(19) United States
(12) Patent Application Publication
(10) Pub. No.: US 2015/0242412 A1
(43) Pub. Date: Aug. 27, 2015

(54) SYSTEM AND METHOD FOR ENHANCED PROCESS DATA STORAGE AND RETRIEVAL

(71) Applicant: GE INTELLIGENT PLATFORMS, INC., Charlottesville, VA (US)

(72) Inventors: Sunil Mathur, East Walpole, MA (US); Michael Solda, Iron Mountain, MI (US)

(21) Appl. No.: 14/428,568

(22) PCT Filed: Aug. 22, 2013
(86) PCT No.: PCT/US13/56081

§ 371 Date: Mar. 16, 2015

Related U.S. Application Data
(60) Provisional application No. 61/706,191, filed on Sep. 27, 2012.

(51) Int. Cl. G06F 17/30

(52) U.S. Cl. CPC G06F 17/30073; G06F 17/30864; G06F 17/30525; G06F 17/30353

(57) ABSTRACT

The subject matter relates to data storage, and more particularly, a system and method to enhance data storage and retrieval. A method of assigning data to at least one region of a data storage device includes monitoring whether an apparatus has generated data. The method includes assigning one of a plurality of system configurations to the data based on at least one criterion. Each of the plurality of system configurations may define different storage locations for data. The method includes acquiring the data and sending the data to be stored on at least one of a plurality of storage devices according to the assigned system configuration.

### BACKGROUND

The subject matter disclosed herein relates to data storage, and more particularly, a system and method to enhance data storage and retrieval.

Process historians are known systems for acquiring and storing data related to one or more processes (i.e., “process data”). Process historians may be referred to as operational historians, enterprise historians, and the like. Process historian software is typically used for monitoring data points that may be utilized in future analyses. Examples of data that may be monitored and stored using a process historian include temperature, pressure, product ID, flow, motion, force, displacement, and the like. This stored data can be utilized to determine a series of events that have led to process errors, to enhance a process, provide long-term storage required to meet compliance needs, and/or for discovering trends in large data sets. These uses may require storing, archiving, and/or organizing large volumes of data, which can be challenging.

Additionally, process historian software may read real-time data from an ongoing process, compress data, time stamp data, and store data for tags in a an archive file that may be qualified by a start time and an end time. The term “tags”, as used herein, may refer to an apparatus that is configured to capture and store data, or identification information associated with an apparatus. Process historian software allows users to query stored data to access pertinent data points. Although it may be optimal for a system to retain stored data indefinitely, this may result in expenditures for storage space and increase the time required to execute and complete queries of data.

In order to overcome the query time issues when storing a large volume of data, some users have chosen to utilize more than one process historian. Using multiple process historians allows a user to search for relevant data on each process historian and stitch the data together outside of the process historian software. Utilizing multiple process historians can be expensive and time consuming.

Thus, there exists a demand for a solution allowing an improvement over existing data storage modalities. There is a demand to provide a data storage system that has sufficient storage to retain all pertinent data, while allowing users to effectively query a large volume of acquired data.

### SUMMARY

According to an example embodiment, a method of assigning data to at least one region of a data storage device includes monitoring whether an apparatus has generated data. The method includes assigning one of a plurality of system configurations to the data based on at least one criterion. Each of the plurality of system configurations may define different storage locations for data. The method includes acquiring the data and sending the data to be stored on at least one of a plurality of storage devices according to the assigned system configuration.

Example embodiments provide that each of the plurality of storage devices may be associated with an attribute, and each of the plurality of system configurations may define the different storage locations based on the attribute.

Example embodiments provide that each of the plurality of system configurations may define different attributes for the different storage locations.

Example embodiments provide that the apparatus may be associated with apparatus identification information and the criterion is the apparatus identification information.

Example embodiments provide that the criterion may be a user-defined data retention period.

Example embodiments provide that the data may be associated with a time value and the criterion may be the time value. The time value may indicate a time that the data was generated.

Example embodiments provide that the apparatus may generate data on a periodic cycle and the criterion may be a frequency of the periodic cycle.

Example embodiments provide that the method may further include generating an archive and associating the data with the archive based on the criterion.

Example embodiments provide that the plurality of storage devices may include at least one of a primary storage device, a secondary storage device, a tertiary storage device, and a non-linear storage device.

According to another embodiment, a data storage server is configured to monitor whether an apparatus has generated data. The data storage server is configured to assign one of a plurality of system configurations to the data based on at least one criterion. Each of the plurality of system configurations may define different storage locations for data. The data storage server is configured to acquire the data and send the data to be stored on at least one of a plurality of storage devices according to the assigned system configuration.

Example embodiments provide that each of the plurality of storage devices may be associated with an attribute, and each of the plurality of system configurations may define the different storage locations based on the attribute.

Example embodiments provide that each of the plurality of system configurations may define different attributes for the different storage locations.

Example embodiments provide that the apparatus may be associated with apparatus identification information and the criterion is the apparatus identification information.

Example embodiments provide that the criterion may be a user-defined data retention period.

Example embodiments provide that the data may be associated with a time value and the criterion may be the time value. The time value may indicate a time that the data was generated.

Example embodiments provide that the apparatus may generate data on a periodic cycle and the criterion may be a frequency of the periodic cycle.

Example embodiments provide that the data storage server may be further configured to generate an archive and associate the data with the archive based on the criterion.

Example embodiments provide that the plurality of storage devices may include at least one of a primary storage device, a secondary storage device, a tertiary storage device, and a non-linear storage device.

According to an example embodiment, a non-transitory computer readable medium may include program segments that, when executed on a computer device, cause the computer device to implement a method of assigning data to at least one region of a data storage device. The method includes monitoring whether an apparatus has generated data. The method includes assigning one of a plurality of system configurations to the data based on at least one criterion. Each of the plurality of system configurations may define different storage locations for data. The method includes acquiring the data and sending the data to be stored on at least one of a plurality of storage devices according to the assigned system configuration.

### BRIEF DESCRIPTION OF THE DRAWINGS

The accompanying drawings, which are incorporated in and constitute a part of the specification, illustrate one or more embodiments and, together with the description, explain these embodiments. In the drawings:

FIG. 1 illustrates an illustrates an example of a communications network, according to an example embodiment;

FIG. 2 illustrates the components of a data storage server being employed by a communication network according to an example embodiment; and

FIG. 3 illustrates a data storage routine according to an example embodiment.

### DETAILED DESCRIPTION OF EMBODIMENTS

Various example embodiments will now be described more fully with reference to the accompanying drawings in which some example embodiments of the invention are shown.

Detailed illustrative embodiments are disclosed herein. However, specific structural and functional details disclosed herein are merely representative for purposes of describing example embodiments of the present invention. This invention may, however, may be embodied in many alternate forms and should not be construed as limited to only the embodiments set forth herein.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments of the present invention. As used herein, the term “and/or,” includes any and all combinations of one or more of the associated listed items.

It will be understood that when an element is referred to as being “connected,” or “coupled,” to another element, it can be directly connected or coupled to the other element or intervening elements may be present. In contrast, when an element is referred to as being “directly connected,” or “directly coupled,” to another element, there are no intervening elements present. Other words used to describe the relationship between elements should be interpreted in a like fashion (e.g., “between,” versus “directly between,” “adjacent,” versus “directly adjacent,” etc.).

The terminology used herein is for the purpose of describing particular embodiments only and is not intended to be limiting of example embodiments of the invention. As used herein, the singular forms “a,” “an,” and “the,” are intended to include the plural forms as well, unless the context clearly indicates otherwise. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Specific details are provided in the following description to provide a thorough understanding of example embodiments. However, it will be understood by one of ordinary skill in the art that example embodiments may be practiced without these specific details. For example, systems may be shown in block diagrams in order not to obscure the example embodiments in unnecessary detail. In other instances, well-known processes, structures and techniques may be shown without unnecessary detail in order to avoid obscuring example embodiments.

Also, it is noted that example embodiments may be described as a process depicted as a flowchart, a flow diagram, a data flow diagram, a structure diagram, or a block diagram. Although a flowchart may describe the operations as a sequential process, many of the operations may be performed in parallel, concurrently or simultaneously. In addition, the order of the operations may be re-arranged. A process may be terminated when its operations are completed, but may also have additional steps not included in the figure. A process may correspond to a method, a function, a procedure, a subroutine, a subprogram, etc. When a process corresponds to a function, its termination may correspond to a return of the function to the calling function or the main function.

Moreover, as disclosed herein, the term “memory” may represent one or more devices for storing data, including random access memory (RAM), magnetic RAM, core memory, and/or other machine readable mediums for storing information. The term “storage medium” may represent one or more devices for storing data, including read only memory (ROM), random access memory (RAM), magnetic RAM, core memory, magnetic disk storage mediums, optical storage mediums, flash memory devices and/or other machine readable mediums for storing information. The term “computer-readable medium” may include, but is not limited to, portable or fixed storage devices, optical storage devices, wireless channels, and various other mediums capable of storing, containing or carrying instruction(s) and/or data.

Furthermore, example embodiments may be implemented by hardware, software, firmware, middleware, microcode, hardware description languages, or any combination thereof. When implemented in software, firmware, middleware or microcode, the program code or code segments to perform the necessary tasks may be stored in a machine or computer readable medium such as a storage medium. A processor(s) may perform the necessary tasks.

A code segment may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

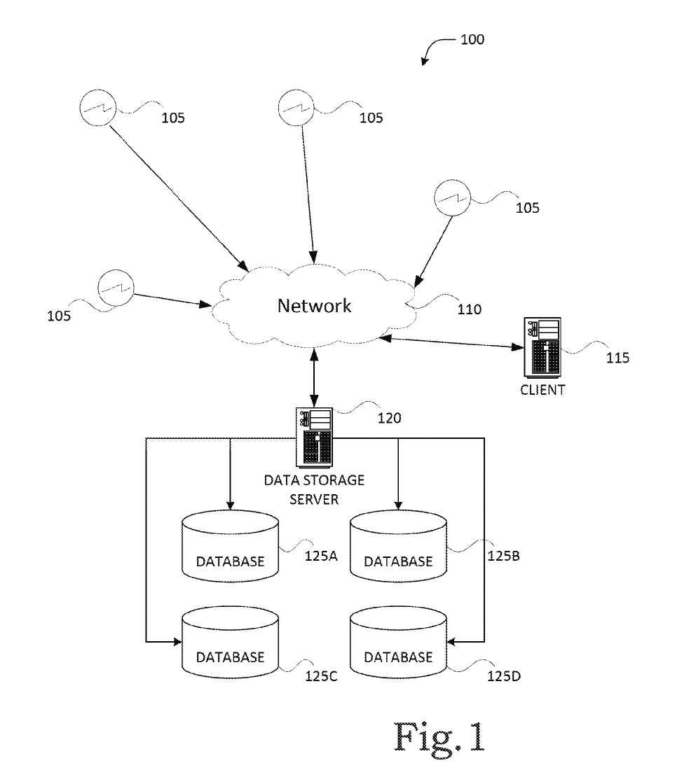

Exemplary embodiments are discussed herein as being implemented in a suitable computing environment. Although not required, exemplary embodiments will be described in the general context of computer-executable instructions, such as program modules or functional processes, being executed by one or more computer processors or CPUs. Generally, program modules or functional processes include routines, programs, objects, components, data structures, etc. that performs particular tasks or implement particular data types. The program modules and functional processes discussed herein may be implemented using existing hardware in existing communication networks. For example, program modules and functional processes discussed herein may be implemented using existing hardware at existing network elements or control nodes (e.g., data storage server 120 as shown in FIG. 1). Such existing hardware may include one or more digital signal processors (DSPs), application-specific-integrated-circuits, field programmable gate arrays (FPGAs) computers or the like.

The exemplary embodiments allow for data generated by an apparatus to be archived in at least one user defined archive file and/or at least one user defined region of a data storage device. A user may determine an appropriate organization of the data points based on the generated data and the attributes of data storage devices. This allows the user to define data with similar rates of collection characteristics into a single archive file and/or data storage system. Organization of data through multiple archive files based on logical grouping of tags may enhance query capabilities and efficient use of storage capabilities.

When a system or device in accordance with example embodiments utilizes numerous time-series archive files, rather than a single time-series archive file, queries can be completed in a shorter time period. For example, a user may wish to have three separate archives: a first archive for data points that must be kept indefinitely for compliance, a second archive for data points that should be kept for ten years, and a third archive for data point that should be kept for three years. Conversely, the archives could be separated by how often each data point is recorded, as well as any other characteristic, criteria, and/or and any combination thereof that a user deems pertinent.

This differs from the known practice, described above, of utilizing more than one process historian. Employing more than one process historian allows a user to search each process historians' time-series archive and stitch the acquired data together to produce a complete data set. However, this will not accomplish the same level of organization that may be accomplished with the example embodiments disclosed herein, as the prior art does not undertake organization means other than the data being archived with other data acquired within a certain time period. Example embodiments allow data to be organized on multiple levels and therefore, stored as such, thereby eliminating the requirement for purchase and implementation of more than one process historian and/or other like databases management system (“DBMS”).

Utilizing multiple time-series archives, queries may become more effective and/or efficient. For example, a user may search a particular time-series archive, thereby eliminating data points that are found in other archives. This is particular pronounced when one examines data points of a first tag that collects data every second, as opposed to a second tag that collects data monthly. If the data from these two tags were stored in the same time-series archive, a query involving the monthly data points would include the data points that are taken every second, which may result in longer query times, as opposed to if such data points were stored in separate archives.

Systems and/or devices according to example embodiments have the ability to produce numerous archives, which may also allow users to organize data points based on a length of period the user determines to be appropriate for archiving. That is, by separating data points into multiple time-series archives based on retention times, such as two years, seven years, and permanent retention, the user can effortlessly delete or otherwise parse-out information that is outside of a desired period, thereby decreasing storage requirements. It should be appreciated that the deletion of data points which are no longer required could be automatically undertaken by various example embodiments.

In addition, a user could organize storage based on viewing frequency. Data points could selectively be stored on different data storage devices, such as solid state drives, storage area network (SAN) devices, network-attached storage (NAS) devices, local hard drives, optical data disks, magnetic storage, flash memory, and/or other like data storage devices, based on the characteristics of the data storage devices. Data points that are required for compliance, but will not likely be accessed for other purposes, may be transferred to slower storage media. Conversely, data that will be accessed regularly can be stored in faster storage media for faster access.

It should be noted that there may be numerous other ways that a user can organize data. Thus, example embodiments allow for data storage to be customized to the needs of one or more applications.

FIG. 1 illustrates an example of a communications network 100, according to an example embodiment. The communications network 100 includes data generating devices 105, network 110, client 115, data storage server 120, and databases 125A-D.

According to various embodiments, client 115 may be a hardware computing device capable of communicating with a server (e.g., data storage server 120), such that client 115 is able to receive services from the server. Client 115 may include memory, one or more processors, and (optionally) transceiver. Client 115 may be configured to send/receive data to/from network devices, such as a router, switch, or other like network devices, via a wired or wireless connection. Client 115 may be designed to sequentially and automatically carry out a sequence of arithmetic or logical operations; equipped to record/store digital data on a machine readable medium; and transmit and receive digital data via one or more network devices. Client 115 may include devices such as desktop computers, laptop computers, cellular phones, tablet personal computers, and/or any other physical or logical device capable of recording, storing, and/or transferring digital data via a connection to a network device. Client 115 may include a wireless transceiver configured to operate in accordance with the IEEE 802.11-2007 standard (802.11) or other like wireless standards.

According to various embodiments, data storage server 120 may include a physical computer hardware system that is configured to provide services for client devices (e.g., client 115) connected to a network (e.g., network 110). Data storage server 120 may employ one or more connection-oriented protocols such as Session Initiation Protocol (SIP), HTTP, and TCP/IP, and includes network devices that use connectionless protocols such as User Datagram Protocol (UDP) and Internet Packet Exchange (IPX). Data storage server 120 may be configured to establish, manage, and terminate communications sessions, for example between data storage server 120 and client 115. Data storage server 120 may also be configured to establish, manage, and terminate communications sessions between two or more client devices. To this end, data storage server 120 may be configured to receive/send communication requests from/to client devices. In various embodiments, data storage server 120 may be configured to operate as a time series database server (TSDS). In such embodiments, data storage server 120 may be configured to handle time series data and/or arrays of data indexed by time, date, and/or time ranges.

According to various embodiments, data storage server 120 is connected to one or more local and/or remote databases 125A-D. In various embodiments, databases 125A-D may include a DBMS. Databases 125A-D may include a relational database management system (RDBMS). In other embodiments, alternate DBMS may also be used, such as an object database (ODBMS), column-oriented DBMS, correlation database DBMS, federated database system (FDBS), and the like.

According to various embodiments, databases 125A-B may be stored on or otherwise associated with one or more data storage devices. These data storage devices may include at least one of a primary storage device, a secondary storage device, a tertiary storage device, a non-linear storage device, and/or other like data storage devices. Furthermore, databases 125A-D may include one or more virtual machines, such that the physical data storage devices containing databases 125A-D may be logically divided into multiple virtual data storage devices and/or databases. Alternatively, each of the databases 125A-D may reside on one physical hardware data storage device.

It should be noted that databases 125A-D may be grouped together, either logically and/or physically, according to one or more criteria, such that the databases 125A-D may be grouped according to an access rate (i.e., how often the database is accessed) and/or a data retention period (i.e., a length of time that data is to be stored). For example, compliance data, which a user may wish to keep for an extended period of time, may be stored in a database on a slower data storage device, such as a secondary storage device or tertiary storage device. Conversely, data that is accessed more often for real-time analysis may be stored in a database associated with a primary and/or temporary data store. For data that can be characterized somewhere between these two extremes, the data may be stored in a long-term compressed format. It should be noted that data may be re-characterized over time, either by the user and/or automatically by the system, and thus, moved to a different database and/or data storage device.

In various embodiments, network 110 may be the Internet. In various embodiments, network 110 may be may be a Wide Area Network (WAN) or other like network that covers a broad area, such as a personal area network (PAN), local area network (LAN), campus area network (CAN), metropolitan area network (MAN), a virtual local area network (VLAN), or other like networks capable of physically or logically connecting computers.

Data generating devices 105 may be computing devices or a system of computing devices, sensors, meters, or other like apparatuses that can capture and/or record data. Once an event is captured and recorded, such an event may be reported to an application or software program and relayed through a network (e.g., network 110) to be stored on a data storage device (e.g., one or more of databases 125A-D via data storage server 120). Data generating devices 105 may also be configured to receive data requests and/or control data from one or more client devices (e.g., client 115). In various embodiments, each of the data generating devices 105 may be configured to communicate with one or more client devices (e.g., client 115) and/or servers (e.g., data storage server 120) via a wired or wireless network (e.g., network 110). In such embodiments, each of the data generating devices 105 may include a wireless transceiver configured to operate in accordance with the IEEE 802.11-2007 standard (802.11) or other like wireless standards.

In various embodiments, data generating devices 105 may be Machine Type Communications (MTC) devices, which are devices that require little (or no) human intervention to communicate with other devices (e.g., data storage server 120, client 115, and/or other like devices). It should be noted that MTC devices may also be referred to as Machine-to-Machine (M2M) communications.

It should be noted that data generating devices 105 may be grouped together, either logically and/or physically, according to at least one criterion. Data generating devices 105 may be grouped according to an application type (e.g., compliance requirements, knowledge discovery, and the like), apparatus type and/or tag (e.g., meter, valve, desktop computer, and the like), data reporting time (e.g., reporting data once per month, reporting data once every minute, and the like), and/or other like criteria.

As shown in FIG. 1, only a single client 115, a single data storage server 120, and a four databases 125A-D are present. According to various embodiments, multiple client devices, multiple servers, and/or any number of databases may be present. Additionally, in some embodiments, client 115, data storage server 120, and databases 125A-D may be virtual machines, and/or they may be provided as part of a cloud computing service.

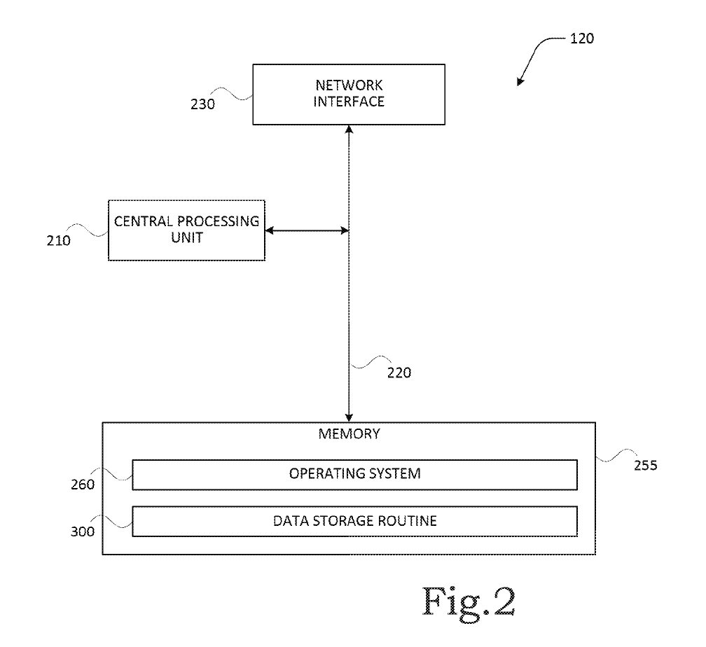

FIG. 2 illustrates the components of data storage server 120 that may be employed by a communication network according to an example embodiment. As shown, data storage server 120 includes central processing 210, bus 220, network interface 230, transmitter 240, receiver 250, and memory 255. During operation, memory 255 includes operating system 260 and data storage routine 300. In some embodiments, data storage server 120 may include many more components than those shown in FIG. 2. However, it is not necessary that all of these generally conventional components be shown in order to disclose the example embodiments.

Memory 255 may be a computer readable storage medium that generally includes a random access memory (RAM), read only memory (ROM), and a permanent mass storage device, such as a disk drive. Memory 255 also stores operating system 260 and program code for data storage routine 300. These software components may also be loaded from a separate computer readable storage medium into memory 255 using a drive mechanism (not shown). Such separate computer readable storage medium may include a floppy drive, disc, tape, DVD/CD-ROM drive, memory card, and/or other like computer readable storage medium (not shown). In some embodiments, software components may be loaded into memory 255 from a remote data storage device (e.g., databases 125A-D) via network interface 230, rather than via a computer readable storage medium.

Central processing unit 210 may be configured to carry out instructions of a computer program by performing basic arithmetical, logical, and input/output operations of the system. Instructions may be provided to central processing unit 210 by memory 255 via bus 220.

Bus 220 enables the communication and data transfer between the components of network element 200. Bus 220 may comprise a high-speed serial bus, parallel bus, storage area network (SAN), and/or other suitable communication technology.

Network interface 230 is a computer hardware component that connects network element 200 to a computer network (e.g., network 110). Network interface 230 may connect network element 200 to a computer network via a wired or wireless connection.

In various embodiments, a transceiver (not shown) may be included with data storage server 120. A transceiver may be a single component configured to provide the functionality of a transmitter and receiver. Accordingly, data storage server 120 may be configured to convert digital data in to a radio signal to be transmitted to one or more devices, and to capture modulated radio waves to be converted into digital data.

According to example embodiments, a data storage system is provided. The system contains one or more apparatuses configured to acquire data. For example, an apparatus could measure temperature, pressure, motion force, load, position, chemicals/gases, sound/vibrations, and the like. Additionally, an apparatus may be configured to receive, record, and/or store manually entered data. Apparatuses may be capable of communicating the generated data to a device (e.g., data storage server 120) that may subsequently store and/or archive the data. Prior to archiving, the system may time-stamp and/or compress the data. Furthermore, this system allows for users to query the archives.

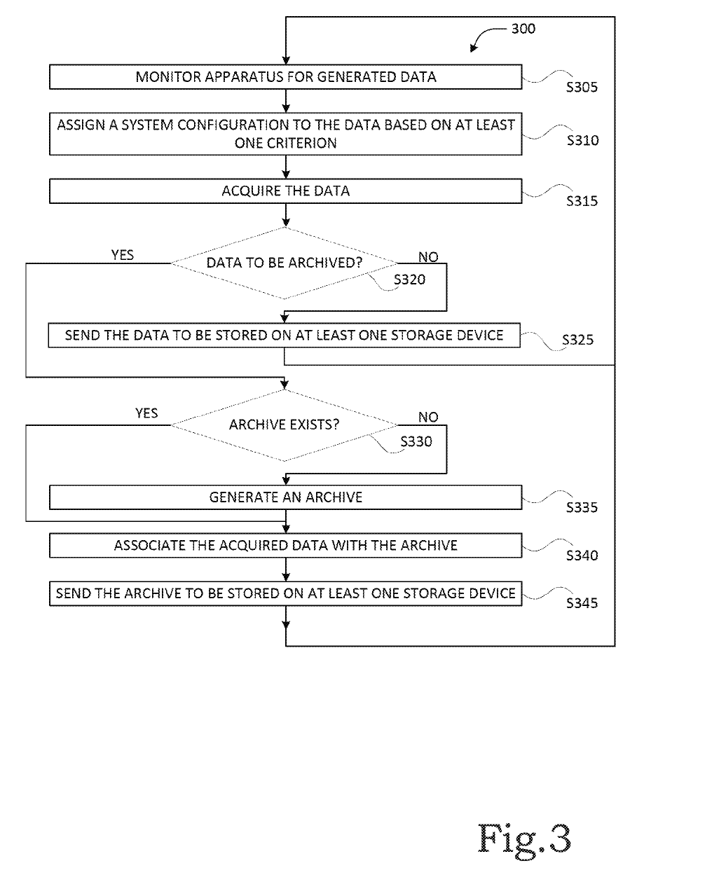

FIG. 3 illustrates a data storage routine 300 according to an example embodiment. For illustrative purposes, the operations of data storage routine 300 will be described as being performed by data storage server 120.

As shown in step S305, data storage server 120 monitors an apparatus for generated data. In various embodiments, data storage server 120 may be configured to query one or more apparatuses for data. In such embodiments, data storage server 120 may query an apparatus on a periodic basis (e.g., once per month, every day at 12:00 P.M., and/or the like). In various embodiments, data storage server 120 may be configured to page an apparatus in response to receiving a request from one or more client devices. In various embodiments, data storage server 120 may be configured to receive an indication from an apparatus indicating that data has been generated after an event has occurred. In various embodiments, an apparatus may be configured to generate data on a periodic cycle (e.g., once per month, every day at 12:00 P.M., and/or the like) and report the data at a frequency of the periodic cycle without being queried. Additionally, data storage server 120 may be configured to monitor one or more apparatuses for generated data using other known methods.

As shown in step S310, data storage server 120 assigns a system configuration to the data based on at least one criterion. As is known, a system configuration may be one or more definitions and/or settings that delineate and/or prescribe elements comprising a computing environment. Additionally, a system configuration may be a set of conditions, constraints, and settings that designate or otherwise dictate how system elements communicate and/or interact with one another. Thus, system configurations may define and/or designate data storage locations for data generated by an apparatus based on at least one criterion. It should be noted that a data storage location may include a physical hardware device, a region of a physical hardware device, and/or a logical location that may be defined by a DBMS, RDBMS, FDBS, and the like.

According to various embodiments, the criterion may be related to the apparatus and/or the data being generated. For example, a system configuration may differentiate between data originating from certain apparatuses and/or tags (e.g., meter, sensor, valve, desktop computing device, and the like). Additionally, a system configuration may differentiate between data based on data reporting time (e.g., reporting data once per month, reporting data once every minute, and the like) or a time value associated with the generated data (e.g., a time and/or date that data is generated). Furthermore, a system configuration may differentiate between data based on application type (e.g., compliance requirements, knowledge discovery, and the like). A system configuration may also designate storage locations base on criteria such as scope (e.g., single data points, one or more time ranges, sample count, and the like). Moreover, a system configuration may designate storage locations based on any combination of the above criteria and/or other criteria that a user deems pertinent.

According to various embodiments, the criteria may be related to one or more data storage devices to which generated data is to be stored. For example, a system configuration may differentiate between data storage devices based on data storage device type (e.g., primary storage device, secondary storage device, tertiary storage device, non-linear storage device, and the like). Additionally, a system configuration may differentiate between data storage devices based on data storage device characteristics and/or attributes (e.g., volatility, capacity, performance, energy use, and/or other like characteristics).

Although example embodiments discussed above describe criteria for designating data storage locations related to the data being generated and/or attributes of data storage devices, example embodiments are not limited thereto, and may include any other type of criteria that a user may deem pertinent, or any combination thereof.

As shown in step S315, data storage server 120 acquires the data. Data storage server 120 may be configured to acquire data using one or more methods that are known. It should be noted that, according to example embodiments, data storage server 120 may be configured to timestamp data once the data has been acquired.

As shown in step S320, data storage server 120 determines if the data should be archived. According to various embodiments, a system configuration may define whether data is supposed to be archived. In such embodiments, data may be allocated for archiving based on one or more of the above-mentioned criteria (e.g., based on scope, apparatus type, data type, application type, and/or other like criteria). If at step S320, data storage server 120 determines that the data should not be archived, data storage server 120 proceeds to step S325 to send the data to be stored on at least one data storage device. Once the data has been sent to be stored on at least one data storage device as shown in step S325, data storage server 120 loops back to step S305 to monitor the apparatus for generated data.

If at step S320, the data storage server 120 determines that the data should be archived, data storage server 120 proceeds to step S330 to determine if an archive already exists for the data. For example, data storage server 120 may be configured to associate a device ID of an apparatus with one or more archives as designated by a user, such that when the apparatus generates data, the data is automatically associated with the user-designated archive(s). By way of another example, data storage server 120 may be configured to associate generated data with a previously generated archive that may have been used for another data set. If at step S330, data storage server 120 determines that an archive already exists for the data, data storage server 120 proceeds to step S340 to associate the acquired data with the archive. If data storage server 120 determines that an archive does not exist, data storage server 120 proceeds to step S335 to generate an archive.

As shown in step S335, data storage server 120 generates an archive. An archive may be any physical or logical grouping of data to improve storage economy (e.g., data compression). Archives may include directory structures, error detection and correction mechanisms, metadata, and/or encryption mechanisms. Therefore, according to example embodiments, data storage server 120 may be configured to generate archives and/or add user-specified data to an archive.

According to various embodiments, archives may be generated according to user defined criteria. For example, archiving may be accomplished using a time series, such that each archive may contain data that is acquired between two points in time. By way of another example, archiving may be accomplished by event, such that each archive may contain data that is acquired after a specified event occurs. Additionally, a user may define numerous archives that may be utilized for any given period of time. Furthermore, a user may organize archived data points into smaller discrete archives, which are defined by criteria that a user has deems pertinent.

It should be noted that the smaller discrete archives that encompass a data set do not have to start and/or end at the same point in time. For example, an annual archive may be created if certain data points are not to be deleted. An annual archive may be appropriate where a user does not anticipate utilizing a data set and the data set cannot be deleted. Alternatively, data points that may be deleted after a specified period of time may be kept in monthly archives. A monthly archive may be queried on a more regular basis, and may allow for queries when a process has been shut down due to an error, for example. Monthly archives may allow for the deletion of data within a month of the three year period the user determined the data should be retained, rather than waiting until the latest data in an annual archive is three years old and therefore, the oldest data is four years old.

As shown in step S340, data storage server 120 associates the acquired data with the archive. Data storage server 120 may be configured to associate data using one or more methods that are known. It should be noted that, according to example embodiments, data storage server 120 may be configured to associate data with one or more archives as the data is being acquired. Additionally, data storage server 120 may be configured to associate previously-stored data with one or more archives and/or rearrange or otherwise manipulate the data associated with an archive.

As shown in step S345, data storage server 120 sends the archive to be stored on at least one storage device. Once the archive has been sent to be stored on at least one data storage device as shown in step S345, data storage server 120 loops back to step S305 to monitor the apparatus for generated data.

This written description uses examples of the subject matter disclosed to enable any person skilled in the art to practice the same, including making and using any devices or systems and performing any incorporated methods. The patentable scope of the subject matter is defined by the claims, and may include other examples that occur to those skilled in the art. Such other examples are intended to be within the scope of the claims.

What is claimed:

1. A method of assigning data to at least one region of a data storage device, the method comprising:
monitoring, by a server, whether an apparatus has generated data;
assigning, by the server, one of a plurality of system configurations to the data based on at least one criterion, each of the plurality of system configurations defining different storage locations for data;
acquiring, by the server, the data; and
sending, by the server, the data to be stored on at least one of a plurality of storage devices according to the assigned system configuration.

2. The method of claim 1, wherein each of the plurality of storage devices are associated with an attribute, and each of the plurality of system configurations define the different storage locations based on the attribute.

3. The method of claim 2, wherein each of the plurality of system configurations define different attributes for the different storage locations.

4. The method of claim 1, wherein the apparatus is associated with apparatus identification information and the criterion is the apparatus identification information.

5. The method of claim 1, wherein the criterion is a user-defined data retention period.

6. The method of claim 1, wherein the data is associated with a time value and the criterion is the time value, the time value indicating a time that the data was generated.

7. The method of claim 1, wherein the apparatus generates data on a periodic cycle and the criterion is a frequency of the periodic cycle.

8. The method of claim 1, further comprising:
generating an archive; and
associating the data with the archive based on the criterion.

9. The method of claim 1, wherein the plurality of storage devices include at least one of a primary storage device, a secondary storage device, a tertiary storage device, and a non-linear storage device.

10. A data storage server, configured to:
monitor whether an apparatus has generated data;
assign one of a plurality of system configurations to the data based on at least one criterion, each of the plurality of system configurations defining different storage locations for data;
acquire the data; and
send the data to be stored on at least one of a plurality of storage devices according to the assigned system configuration.

11. The data storage server of claim 10, wherein each of the plurality of storage devices are associated with an attribute, and each of the plurality of system configurations define the different storage locations based on the attribute.

12. The data storage server of claim 11, wherein each of the plurality of system configurations define different attributes for the different storage locations.

13. The data storage server of claim 10, wherein the apparatus is associated with apparatus identification information and the criterion is the apparatus identification information.

14. The data storage server of claim 10, wherein the criterion is a user-defined data retention period.

15. The data storage system of claim 10, wherein the data is associated with a time value and the criterion is the time value, the time value indicating a time that the data was generated.

16. The data storage server of claim 10, wherein the apparatus generates data on a periodic cycle and the criterion is a frequency of the periodic cycle.

17. The data storage server of claim 10, further configured to:
generate an archive; and
associate the data with the archive based on the criterion.

18. The data storage server of claim 10, wherein the plurality of storage devices include at least one of a primary storage device, a secondary storage device, a tertiary storage device, and a non-linear storage device.

19. A non-transitory computer readable medium including program segments for, when executed on a computer device, causing the computer device to implement a method of assigning data to at least one region of a data storage device, the method comprising:
monitoring, by a server, whether an apparatus has generated data;
assigning, by the server, one of a plurality of system configurations to the data based on at least one criterion, each of the plurality of system configurations defining different storage locations for data;
acquiring, by the server, the data; and
sending, by the server, the data to be stored on at least one of a plurality of storage devices according to the assigned system configuration.
